(19) United States
(12) Patent Application Publication
(10) Pub. No.: US 2003/0200163 A1
(43) Pub. Date: Oct. 23, 2003

(54) System for and method of deriving funds for a financial vehicle

(76) Inventors: John B. O'Riordan, London (GB); Robert P.B. O'Riordan, London (GB); Dan O'Riordan, Virginia Water (GB)

Correspondence Address: SIDLEY AUSTIN BROWN & WOOD LLP, 717 NORTH HARWOOD, SUITE 3400, DALLAS, TX, 75201, US

(21) Appl. No.: 10/257,563

(22) PCT Filed: Apr. 12, 2001
(86) PCT No.: PCT/GB01/01695

(51) Int. Cl. G06F 17/60

(52) U.S. Cl. 705/35

(57) ABSTRACT

A system for deriving funds for a financial vehicle such as an investment fund on behalf of a customer comprises means for inputting data on financial transactions to a customer account. The processor running the account increases the value of each transaction as to an amount related to the amount of the transaction by rounding it up to the nearest pre-set currency unit value and adds the increase in the amount to a notional accrual account. At the end of an accounting period the entries in the accrual log are totalled, debited to the money transmission account and transferred to the financial vehicle on behalf of the customer automatically.

The present invention relates to a system for and a method of deriving funds for a financial vehicle on behalf of a customer.

For many individuals the decision to start investing is often perceived as complex and onerous. Even putting money aside requires the opening of an account with a bank. A large aspect of the reluctance on the part of the individual is connected with the formalities of filling in forms and administering matters on an on-going basis. Customer inertia restricts opportunity and many individuals postpone the decision until they are faced with lifestyle requirements, such as the need for a mortgage on real estate or the need to start a pension scheme which is often considerably after it ought to have been dealt with.

Increasing economic uncertainty and the retreat of the state from the automatic provision of an adequate safety net for individuals has made personal financial provision increasingly important. The potential for take-up of financial vehicles, such as investment products, is available to significant proportion of the working population. However, this is not presently reflected in the actual take-up. Banks and other financial institutions strive to keep the paperwork and the forms to a minimum to address this in order that customer inertia is minimised.

A customer of a bank is a ready target for introducing other financial products provided by the same institution. Banks recognise the benefits of a multi-product relationship with their customers and understand the need for customers to start their investment plans as early as possible. However, resistance to cross-selling initiatives (which are often considered intrusive) and customer inertia has severely limited the benefits accruing from selling investment services to existing banking customers. Thus, for many financial institutions, extracting additional value from a single product customer base is a particular strategic issue to be addressed. Significant benefits can accrue from a successful cross-selling program. These include an additional source of revenue, leverage of existing product resource and infrastructure and a deepening of the relationship with the customer when they become a multi-product holder.

A number of business studies has conclusively shown the rise in long term value of a customer when they partake of multiple products from an institution. Not only is there additional income, but the institution can become the customer's preferred service provider, with the relationship and trust engendered providing significant future value in additional income and referral opportunities.

Many financial institutions are organised on divisional product lines, with product information and customer data being held in product-specific systems. If the product to be cross-sold comes from outside the ‘product family’ (i.e. an investment product introduced to a customer in a banking database), then significant barriers can be encountered in terms of logistics, culture and timing.

Furthermore, considerable customer resistance to cross-selling initiatives stand in the way. Despite extensive use of sophisticated customer relationship programs which seek to predict when customers will be the most susceptible to a product sale, this consumer resistance is probably the biggest obstacle to successful cross-selling.

A bank faced with reporting to its customers about every day consumption transactions has a very difficult task in entering into a dialogue about addressing their investment needs. Yet it is considered that the vast majority of customers would not question the importance of building up a financial nest egg for the future. Unless a lump sum becomes available to trigger an investment decision, many savings and investment decisions are simply postponed or delayed. The majority of marketing communications geared towards obtaining commitment to purchasing a savings/investment product fail due to the customer inertia and apathy referred to above. Customers often know they should do more to provide for their future, but the reluctance to do anything about it often prevails.

No institution is known to the inventors that has successfully built a cross-selling model for the selling of investment products into a banking customer base. To succeed an institution must address the issue of customer inertia and make the investment mechanism as simple and straightforward as possible.

It is an object of the present invention to provide a system and method for deriving funds for a financial vehicle on behalf of a customer that exploits data processing technology to address the issue of customer inertia in providing funds for the financial vehicle.

According to the present invention there is provided a system for deriving funds for a financial vehicle on behalf of a customer, the system comprising: input means for entering financial transactions to a customer account in a memory means; processor means for increasing the value of each transaction to an amount and for entering the increase in the amount into a log in the memory means; means for establishing the end of an accounting period and for generating an output signal, the processor means being responsive to the output signal at the end of the accounting period, and to credit the increase(s) in the amount(s) to the financial vehicle on behalf of the customer.

The present invention provides a system that can automatically link the process of investment with every day consumption-led banking transactions. The process avoids the inertia and apathy that otherwise hinders investment decisions. It provides the opportunity for individuals to view their increases in the amounts of each transaction as a form of ‘small change’ which can be salted away in the financial vehicle of choice without effort once the system is established in respect of the customer.

The invention exploits the processing ability of computers to handle high volumes of transactions. However, the inventors have recognised that there is a useful distinction to be drawn between notional movement or establishment of funds by book entry in a processor-bound accounting system and the physical or electronic movement of funds between independent accounts. By establishing a notional log for the increments on the transactions, the invention can be implemented at minimal additional capital and transaction cost to the service provider. The decision to set up the financial vehicle is a one-off exercise followed by trickle funding through the normal activity in financial transactions. While the increase in the amount can be credited to the financial vehicle at each financial transaction the actual movement of funds does not necessarily take place at each financial transaction event, but can be after a reasonable amount has built up that can be moved more cost-effectively. In this way, the financial transaction serves the two ends of processing the financial transaction as normal and deriving the funds for the financial vehicle. By this means the realistic potential for investment is extended across a broader range of income levels and people otherwise less likely to make the decision to deal in the chosen financial vehicle.

The financial transactions can be those associated with a credit card account held by a customer or a money transmission account (ie. a bank account by which it is possible to transfer money), such as a bank current account. The increase in the value of each transaction can be by way of rounding up the figure to the nearest one of a set of nominated values (eg. consecutive whole numbers) of currency units. Alternatively, a fixed amount can be added to each transaction. In a further alternative, the increase is arrived at by adding a percentage of the value of the transaction.

The input means may be an electronic data entry system by which each transaction can be entered manually by means of a keyboard or electronically over a communications system, such as the Internet. Other forms of payment processing system, such as those provided by VISA, Mastercard, American Express, etc., use networks and payment processing systems to which the present invention is applicable.

The processor means are typically a server communicating with the input means which has, or is linked to, a memory containing the customer account data. While separate memories can be provided for the customer account and the log, the same memory can be used for both, such that separate addressable sectors are available which can be accessed independently.

The present invention can be put into practice in various ways some of which will be described by way of example with reference to the following drawings in which:

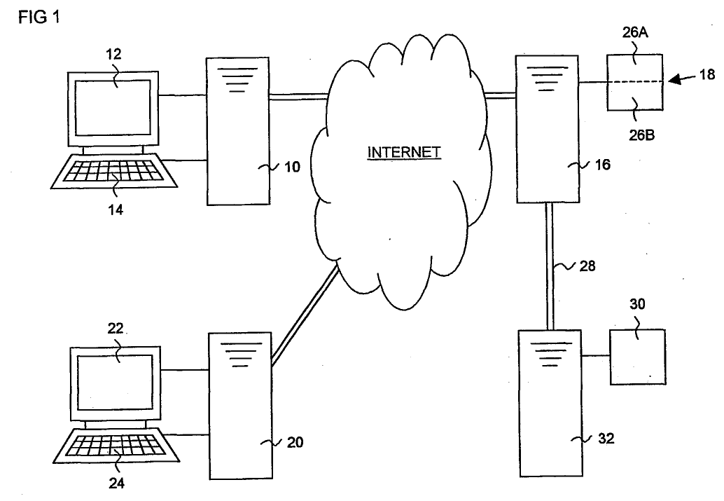

FIG. 1 is a schematic block diagram of a credit card-based electronic funds transfer system by which the invention can be put into practice;

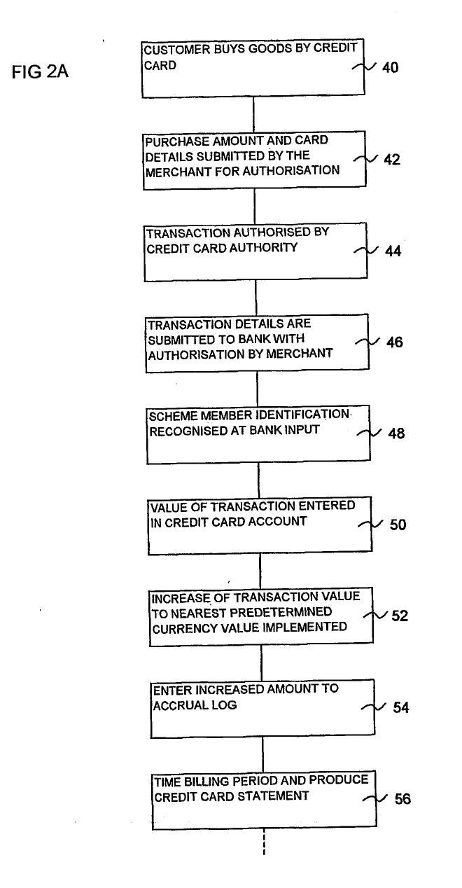

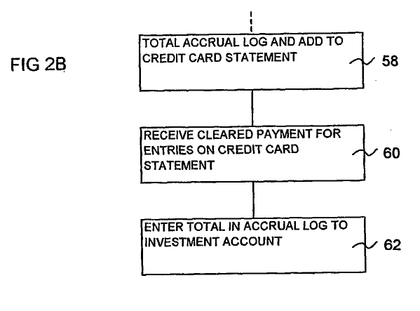

FIG. 2 is a flow chart of the transactions enabled according to FIG. 1;

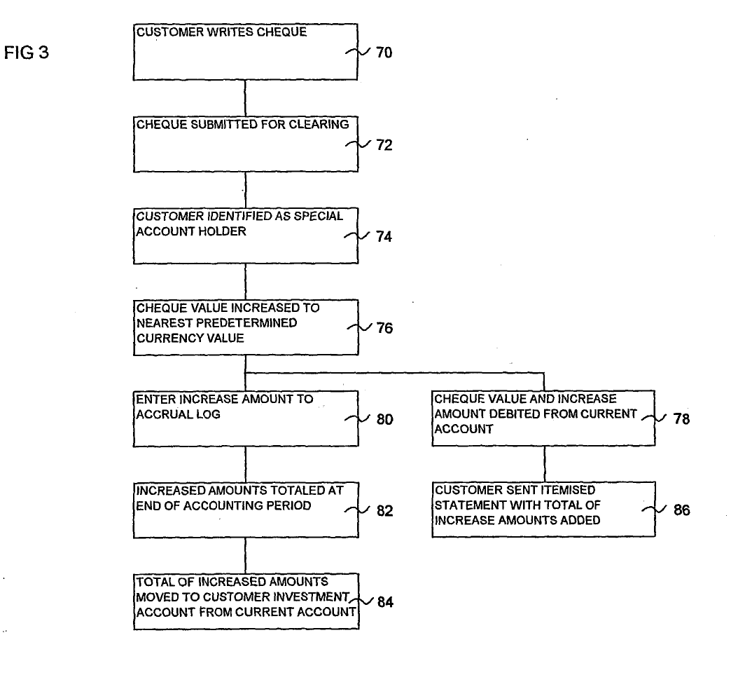

FIG. 3 is a flow chart of a cheque-based transaction enabled by the invention;

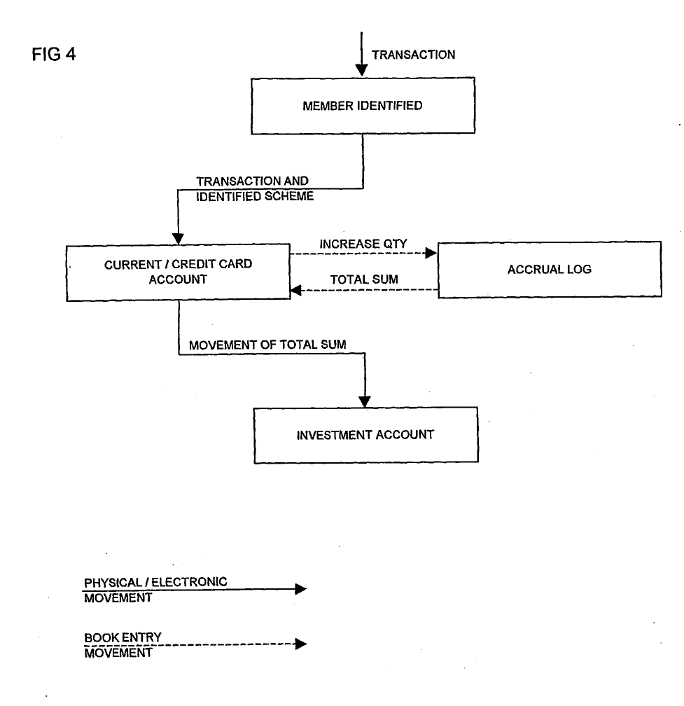

FIG. 4 is a generalised flow chart of the present invention; and

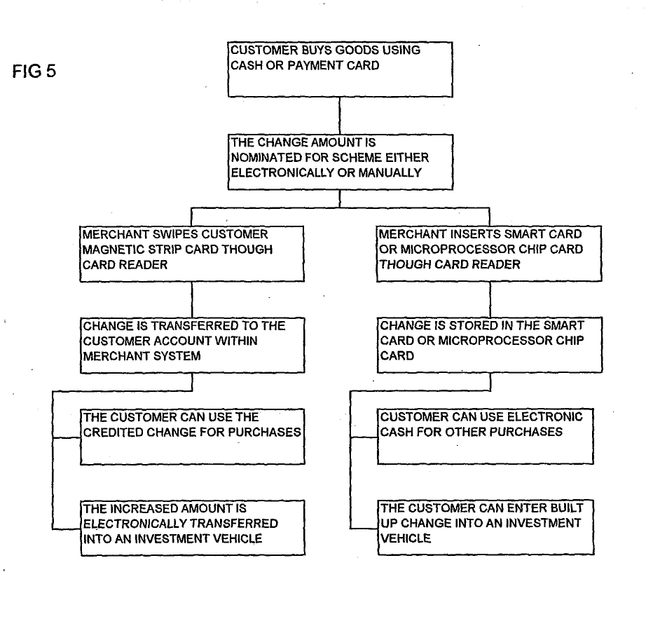

FIG. 5 is a flow chart of a cash-based transaction embodied by the invention.

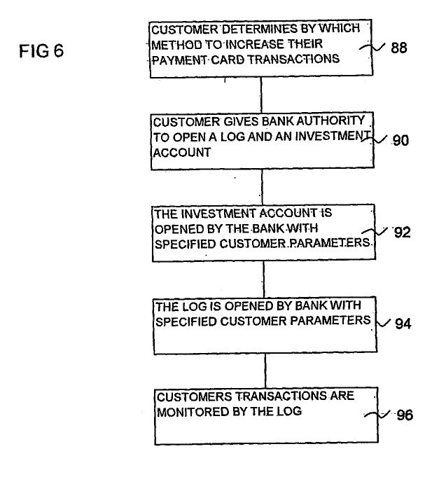

FIG. 6 is a flow chart of setting up an account according to the invention:

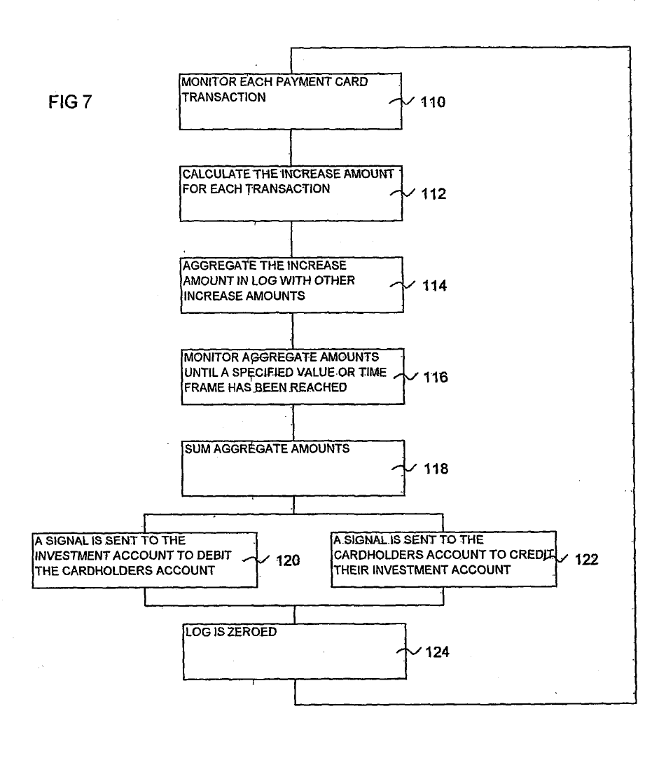

FIG. 7 is a flow chart of operation of the log; and

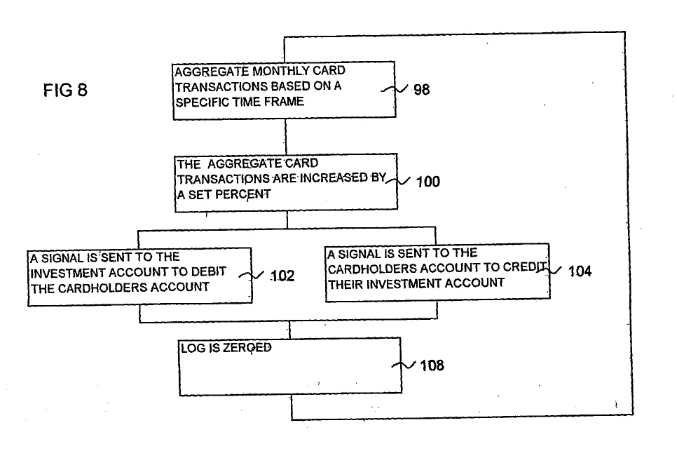

FIG. 8 is a flow chart of another form of operating the log.

Referring to FIGS. 1 and 2A and B of the drawings, a credit card-based implementation of the invention is shown. This embodiment of the invention is Internet-based. It will be appreciated that the invention can be implemented using various other forms of communication, for example payment processing networks, as well as manual transfer of data and input of data to the bank server to be described.

A merchant site comprises a merchant server 10, a display 12 and an input keyboard 14. The server is connected to the Internet by TCP/IP protocols in conventional manner. Also connected to the Internet is a bank server 16 and its associated database memory 18. The bank server 16 maintains the software for processing clearance of credit card transactions applied for over the Internet (or payment processing network) by the merchant server 10 according to the invention. A customer having a user site 20, a display 22 and an input keyboard 24 communicates with the merchant server 10 over the Internet to make purchases of goods and/or services.

Intermediate initiation and completion of the transaction, the merchant receives details of the customer credit card in a secure way. In response, the merchant server 10 communicates over the Internet (or payment processing network) with the bank server 16 in a similarly secure way to verify the credit worthiness of the customer. On completion of the transaction the credit card and transaction details, including the value of the transaction, are sent by secure means over the Internet (or payment processing network) to the bank server 16 for addition to the customer credit card account. Thus far, the exchange of information and the manner in which the exchange is conducted is conventional in all but one respect and can be effected in known ways.

Referring in particular to FIG. 2A and B, the customer purchases goods or services by credit card at step 40. The purchase amount and the credit card details are submitted for authorisation at step 42. The transaction is authorised (or not) by the credit card authority and confirmation returned to the merchant at step 44. The merchant then completes the transaction by submitting the details to the bank server at step 46. According to the invention the bank server 16 is programmed to recognise the account as one signifying that the customer belongs to a particular scheme. The signification of the customer's status as belonging to the particular scheme may be by way of a field or header in the data provided in the credit card details. On recognition of the signifying data, the transaction is treated differently to normal credit card transactions. Once the customer is identified according to the signifying data at step 48 in FIG. 2, the transaction is assigned to the customer's credit card account at step 50 in memory 26A in FIG. 1. In so doing, the basic credit card transaction is complete. At the end of the predetermined accounting period the credit card transactions are compiled by the bank into a bill which is sent out to the customer.

At the same time as the transaction amount is assigned to the credit card account at step 50 in memory 26A, the bank server 16 is programmed to establish the increase required of the transaction to the nearest one of a predetermined set of currency values at step 52. For example, the increase of the transaction amount may be to the nearest whole currency unit, such as £1, £2, £3 etc., or to the nearest higher of another predetermined set of currency values, such as £1, £5, £10 or £50 according to which of these values the transaction falls immediately below. This creates an increase in the amount of the transaction that is the difference between the value of the transaction and the figure to which it is rounded up. This difference is assigned to an accrual log 54 in memory 26B. It will be appreciated by the person of ordinary skill in the art that the accrual log is a software operation in memory 26B. The memory may be separate from the memory 26A or simply an apportionment of addressable memory space within the same memory device.

At each credit card transaction the accrual log is supplemented with an entry according to the increase amount. The bank server 16 is programmed to serve as a timer and to produce a credit statement at step 56 at the end of a predetermined accounting period. Also at the end of the accounting period, that may coincide with the billing period for the credit card account, the entries in the accrual log are totalled and added to the credit card bill 58 which also comprises the list of entries for the credit card transactions themselves. While the invention is described such that the accounting period in respect of the accrual log is coincident with that for the credit card account, this does not have to be the case. The accounting period in respect of the accrual log may be variable and, for example, triggered by the amount in the accrual log exceeding a particular threshold. It will be appreciated that there is a cost associated with transferring the amount in the accrual log to the financial vehicle of choice (to be described below). By triggering such a transfer according to the level of funds in the accrual log, the cost-effectiveness of the transfer can be maintained. Alternatively, the amounts in the accrual log can be totalled for transfer over a period based on a set number of billing periods for the credit card account itself.

Upon clearance of the credit card bill at step 60, including the accrued amount, by conventional payment processing the accrued amount which is cleared (or a proportion of it if only a proportion of the difference between the total credit card bill and the total for the basic credit card transactions is cleared) is moved over (in this case) local area network (LAN) communication 28 at step 62 to an investment account. The investment account is usefully associated with the bank and held in memory 30 and processed by server 32. The investment account may, on the other hand, be unconnected with the bank running the credit card account. In the alternative, if the customer pays only a proportion of the bill, then the whole of the accrued amount is still moved into the investment vehicle and the customer has to bear the cost of the interest on the balance owing on the bill.

As mentioned above, the event of a transaction represents a cost to the bank. The events referred to in FIG. 2 between identification of the customer as belonging to the scheme enabled by the invention and application of the accrued surplus to the investment vehicle are such transactions. However, the internal logging of the accrued amounts and their entry to the accrual log in memory 26B are processor activities having no capital or transactional cost implications over and above those associated with the conventional transactions, save for the apportionment of a relatively small amount of memory space for the purpose.

The invention, therefore, exploits the processor/memory ability to deal with potentially many relatively small amounts to derive the accrued funds without disturbing the basic credit card clearance and billing procedure. Funds are automatically derived for the investment vehicle from many small amounts added frequently and for those amounts to be transferred as a total to the investment vehicle only once in the billing period of choice for the accrual log.

In addition to providing a mechanism for investing funds, the rounding up feature of the present invention also provides a means for a reduction in the interest rate charged by the credit card issuer as a result of the collateral represented by the investment account. A credit card issuer typically charges interest on credit accounts for which the balance is not fully paid in a single billing cycle. These interest rates can be rather substantial and accrue until the entire balance of the account is paid by the user. One reason for the substantial interest rates charged to credit card users is the high rate of default on accounts by credit card users. The rounding up feature of the present invention provides collateral for the credit card account that can be used in the event of a default. In other words, the formation of the investment account by the credit card user provides a sum of money that can be accessed by the credit card issuer in the event of default by the credit card user. Accordingly, the interest rate paid by the credit card user that has placed money into the investment account contemplated by the present invention may be reduced on account of the presence of collateral as represented by the investment account. Thus, the present invention provides a mechanism for a reduction in the interest rate charged to the credit card user. However, that reduction occurs not through rebates or payments by the credit card issuer, but rather through the mere existence of the investment account and the value of the total investment in that account.

FIG. 3 is a current account-based implementation of the invention. In this case, the system is based on physically writing cheques against an account containing adequate funds.

As is conventional, the customer writes a cheque for goods or services at step 70 and it is submitted for clearing by the merchant at step 72 to the merchant's bank. In a conventional manner the cheque would simply be cleared and the amount debited from the customer current account. However, according to the invention the customer bank current account server 16 identifies the account as one requiring rounding up of the cheque amounts according to the nominated arrangement at step 74 and performs the rounding up at step 76, and submits the increased amount for clearing from the customer current account at step 78. If sufficient cleared funds are available according to the normal criteria, the increased amount is logged in the accrual log. The cheque value is transferred to the merchant account in conventional manner. The increase in the amount according to the formula is assigned by the server to the accrual log in the memory at step 80. At the end of a suitable accounting period, the accrued amounts are added up at step 82. The total is then debited to the current account and transferred to the investment vehicle of choice to the benefit of the customer at step 84. The customer is sent an itemised statement of cheque transactions and an entry for the total accrued and transferred to the investment vehicle at step 86.

At the end of a current account accounting period, the accrual log is totalled as before and transferred. As before, the accounting period in respect of the accrual log is not tied to that for the current account. The accrued funds appear on the customer current account statement as a separate entry and the cheque amounts appear according to the value of the originally written cheques.

A generalised flow chart of the process of the invention is shown in FIG. 4. The present invention seeks to align an individual's everyday consumption needs with the requirement for enhanced financial security. This is achieved through directly linking standard banking transactions based on, for example, credit/debit/smart card transactions, cheques, standing orders, direct debits and the like with a savings/investment program.

The rounding up provides the opportunity to choose to automatically create funds for a nominated financial vehicle for more transactions carried out in respect of a particular account or chosen transactions within that account. By choosing values of £1, £5 and £10, for example, a transaction valued at £0.67 p can be rounded up to £1, a transaction valued at £2.95 can be rounded up to £5 and a transaction valued at £7.40 can be rounded up to £10. Transactions. valued above the set figure can either not be rounded up at all or can be increased by a set amount, for example the maximum £10 from the set of possible increases. The increases could be set by the bank or chosen by the customer.

The financial vehicle to which the derived finds are applied could be any existing bank vehicle or another financial vehicle independent of the bank. but nominated by the customer for receipt of the funds. Operation of the customer account and the financial vehicle do not change except insofar as the system is arranged to nominate the funds in respect of relevant transactions. Consequently, the customer can operate a customer account and the financial vehicle as normal, making additional payments and/or withdrawals according to the terms under which the vehicle is operated. The present invention complements the existing operations and product processes associated with the bank. It does not conflict with the existing product protocol. If the customer exceeds (e.g.) a credit card limit in respect of which the invention is operated, the system could be programmed to disable the transfer of notionally derived funds so that it is postponed until the credit card balance is taken below the designated credit card limit. Only when the credit card or a current account is within pre-arranged limits or is not overdrawn will the process of deriving finds according to the invention be put into effect. Thus, existing product rules can be arranged to take priority over the procedure for deriving funds according to the invention.

The different predetermined amounts are targeted at different types of consumers and savings plans. For example, the £1 and £5 figures can be targeted at individuals who would like to invest amounts that reflect the small amounts of change that are usually received during a cash purchase. Those amounts can be significant when aggregated and allowed to accrue interest and/or an investment return over a substantial period, such as twenty years for a child's education. £50 and £100 values can be targeted at individuals who are interested in substantial savings, but realise that such savings are not possible for them unless through a forced account system.

The proposed system can be implemented through either a special credit card, debit card or payment card, or by special account associated with the card. Upon purchase of a product from a merchant, the consumer uses the credit card with the system account. The merchant then utilises the merchant acquirer's credit processing system in the conventional manner to cause the charge to be sent to the credit card or debit card network.

At the time that the charge is posted at the bank with which the customer account is associated, or at the time that the charge is being invoiced to the customer, the amount is then rounded up to the nearest whole number in accordance with the chosen amounts. The consumer is then charged for the full amount of the transaction (i.e. the cost of the purchased good or service and the increase) at the end of the accounting period. The incremental rounded up amount is then transferred to the investment account.

In yet another embodiment of the system of the present invention the financial benefits to the bank or other operators of the system are obtained from a percentage of the investment gained from the invested funds.

The invention can be implemented in respect of other financial transactions. For example, a utilities company (such as a telephone company) which has many small entries in an accounting period could run the invention to beneficial effect. In this case each chargeable telephone call could be rounded up to the nearest whole number currency unit and the movements logged in an accrual log as described. At the appropriate accounting point (as described) the telephone company could transfer the cleared amount equivalent to the accrued sum to a nominated financial vehicle. Thus, the present system may achieve. additional advantages by the use of a centralised rewards and investment management function, or administrative agents. The centralised investment management function or agent interfaces with the banks and customers to administer the entire program. The management agent collects the incremental amounts and pools the funds for investment in standard investment vehicles. The use of an agent permits consumer choice in the type of investments. For example, the agent may be affiliated with a particular mutual funds company and thereby allow the consumer to choose. between growth or index stock mutual funds.

The agent can also administer the program applications through participating banks. The agent then cross references applications so that each customer receives a single investment account, even though the customer may be using more than one type of account or credit card.

In another embodiment it is arranged that the customer can communicate with the institution (bank or other agent running the scheme) to vary the increase amounts or the way in which the increases are carried out in respect of each transaction. This may be by secure communication carried out remotely over the communications network supporting the scheme, a telephone line using password access or in person at the outlet of the institution.

Additionally, the different spending habits associated with different customer accounts can be catered for by applying different rates of increase amounts to different accounts all running in conjunction with the scheme. Thus, the telephone account may be arranged to apply an increase based on smaller gaps between consecutive integer currency units because the telephone creates transactions very frequently. On the other hand, the credit card account can be assigned a greater gap between integer currency units as it is less frequently used and allows the customer to bear the greater increases as they are less frequent.

The customer can benefit from the invention by having more than one financial vehicle (eg. retirement fund, mutual fund, money market fund) arranged to be credited with the derived funds. These may be apportioned as percentages according to customer preference. Alternatively, the increases could be assigned to other money transmission accounts (eg. son's/daughter's accounts).

The system of the present invention may also be implemented with regard to cash transactions as illustrated in FIG. 5. In such a system, the buyer belongs to a special program which is accepted by particular merchants providing merchant accounts for customers. At the time of purchase, the buyer is offered the option of rounding up the transaction or having the excess change from the transaction placed into their customer account. For example, a purchase of £10.35 allows the option of placing the excess change from a cash payment of £11.00 into a customer account. Set percentage increases or set amount increases, as previously described, would also be possible with this cash-based program.

Implementation of the cash-based system is contemplated through the use of either a credit/debit/smart card for the amount of excess change, or the use of a special magnetic stripe card or microprocessor embedded card. Such a card would be a standard card with a plastic or paper substrate and a magnetic stripe across one side or an integrated circuit/microprocessor chip embedded in the card. The participating merchant would swipe or insert the card through a standard card reader and the magnetic stripe or microprocessor chip information would indicate that the customer account and related system is to be accessed and credited with an amount of money. The merchant would then enter the amount of the excess cash into the card reader for processing into the customer account. The system would provide for debiting of the merchant account for amount of the excess change. Magnetic stripe cards are currently used at grocery stores and other merchant locations as “special value” cards that indicate, for example, certain promotional discounts should be provided to that customer. Similarly, such special value cards are currently used for recording an aggregation of the total amount purchased from the merchant (or a collection of merchants), which provides rewards or discounts to the customer upon achieving particular purchase amounts.

In the same manner, the magnetic stripe/microprocessor cards would be used for participants in the rounding program of the present invention. The excess cash amounts would be aggregated and then transferred into an investment vehicle as previously described. While conventional credit/debit/smart cards could also be used in this manner, the special magnetic stripe/microprocessor program card would be directed to users for cash transactions. As a result, the system of the present invention permits a “forced” savings for the customer through a cash transaction (in addition to the previously described credit card system) as well as provides the advantages of the present invention to individuals who might otherwise not use credit/debit/smart cards. Accordingly, the financial services company sponsoring the rounding program for cash transactions will be given access to a group of customers that otherwise might not be inclined to participate in savings through that financial services company and might not otherwise have ownership of one or more credit/debit/smart cards. In this manner, children might also participate in a round up program without the need for a credit/debit/smart card and the necessary approvals to qualify for a credit/debit/smart card.

In another embodiment, the buyer is offered the option of electronically storing the excess change or transaction increases directly into a smart card or an integrated circuit/microprocessor chip embedded in the card. In this way the customer can use this electronic cash for other purchases or deposit the money into a customer account or investment vehicle.

It will be appreciated that the system according to the present invention is based on incentives for investment but incentives may be used in a number of different ways. For example, the investment vehicle could be based on traditional retirement funding or education funding for children. Alternatively, however, the investment vehicle could be based on savings for vacations or other goods or services. The investment could also be used to encourage certain behaviour. For example, smokers could be encouraged to give up smoking by investing the money they otherwise would have spent on cigarettes. Similarly, parents could reward children for good behaviour or other actions with additions to an adult account, or to a separate account for their children which may then be used for games or other special rewards for the children.

In operation, the following features are contemplated for the system according to one embodiment of the present invention:

1. A separate accrual log is activated for the consumer, or a special feature is added to the existing account to provide the benefits of the present invention. Parents may have a separate account for their child's use in the short term (i.e. rewards for good behaviour) or for long term goals (i.e. savings for financing of the child's education).

2. Upon transfer of the charge from the merchant to the card issuer or bank, the amount of the specific transaction or the amount of the monthly credit statement is increased by a predetermined incremental amount at the time of charge transfer. The predetermined incremental amount for the customer is transferred to the administrative agent for further processing.

3. The administrative agent collects the funds relating to a number of consumers and buys units of a pooled investment vehicle. The agent maintains separate accounts for each individual so that proceeds of the investments can be appropriately applied to individual accounts.

The present invention provides a forced savings vehicle in which its funds are set aside from a financial transaction and eventually applied to a financial vehicle. In one form, it is established according to the process steps in FIG. 6.

As described, the rounding of the payment can occur at the time of the transaction, after each transaction, or at the end of a set period of time, such as a monthly period at which time an invoice is sent to the customer for a series of credit card transactions. The system of this application uses an implementation of the rounding system in a credit card environment in which the rounding function occurs in the background of the account by means of the log which has a set of processes which interrogate the transactions which take place in credit card accounts, current accounts, smart card accounts or any designated account and carries out a set of functions on the data provided and processes according to the rules established for that account.

Referring to FIG. 7, a virtual log based on the notional increase of each transaction operates in the following manner:

Step 1: monitor each transaction in the nominated account.

Step 2: calculate the specified type of increase of each transaction. In other words, round up by a set amount, a percentage or to a selected whole number value, for each transaction.

Step 3: accumulate the notional increases for each transaction.

Step 4: monitor the accumulated balance in the log on one or more of the following criteria and flag it once the criteria has been met:

a) exploration of a predetermined period of time or;

b) reaching a predetermined amount or value.

Step 5: sum the aggregate amounts once the flag has been raised in Step 4.

Step 6a): send a signal to the credit card account, current account, smart card account or designated account which instructs the account to send the accumulated monies in the log to the customer's financial vehicle or;

b): send a signal to the financial vehicle to debit the credit card account, current account, smart card account or designated account with the aggregated balance.

Step 7: once the signal/instruction has been sent, the log is automatically zeroed.

Alternatively, referring to FIG. 8 another set of operations uses a log based on a single percentage increase which operates in the following manner:

Step 1: the notional log monitors and flags the customer's credit card account, current account, smart card account or any designated account on a cyclical timeframe.

Step 2: calculate the notional percentage increase on the total expenditure associated with the designated account for that timeframe.

Step 3a): send a signal to the credit card account, current account, smart card account or any designated account, which instructs the system to send the accumulated monies in the log to the customer's investment account;

b) send a signal to the investment account to debit the credit card account, current account, smart card account or designated account with the aggregated balance.

Step 4: once the signal/instruction has been sent, the log is automatically zeroed.

The customer can nominate to automatically increase their payment card transactions either by rounding a transaction to the nearest whole number amount or to a set or predetermined amount. For instance, a charge of $3.53 could be rounded to the nearest dollar or predetermined amount, say $10. The excess would be logged and then transferred after a timeframe or specified amount was reached into an investment account acting as the financial vehicle. The customer would also have the option of increasing their transactions by a percentage, as in 5% of the purchase price, or by the actual purchase amount, or by a specific predetermined amount, such as $10.

In either case, the log operates in the background of the customer's credit card account. With a conventional credit card account, the customer uses a credit card to pay for goods or services with a merchant. The customer or card holder has an agreement with the issuer of the credit card in which the customer promises to pay a minimum monthly payment and stay within a credit limit. The issuer, which is a bank or other financial institution, is ultimately responsible for payment of the debt of the card holder. The issuer typically has a contract with a bankcard association (such as VISA or Mastercard) in which the issuer agrees to accept the risk of card debt and to support the bankcard association. The bankcard association may be associated with an merchant acquirer, so that merchants do not have to deal with multiple bank card associations.

The log is preferably designed to operate in conjunction with the issuer, but can be used with the bankcard association or merchant acquirer. The log operates to monitor the credit card account and transfer money to the investment account. Another embodiment uses the notional log only to calculate the notional percentage increase and to transfer the physical money, from the total customer account expenditure, at the end of a time frame, such as monthly, quarterly or any other type of cycle.

The interest rate paid by the credit card user that has placed money into the investment account contemplated by the present invention may be reduced on account of the presence of collateral as represented by the investment account. Thus, the present invention provides a mechanism for a reduction in the interest rate charge to the credit card user. However, that reduction occurs not through rebates or payments by the credit card issuer, but rather through the mere existence of the investment account and the value of the total investment in that account.

The bank or issuer sets up a program that monitors the customer's investment account that is associated with their credit card account via the log. The program sets parameters which raise flags once the customer has reached certain thresholds in the investment account, such as $1,000, $2,500, $5,000, etc. Once the threshold has been reached, the bank is able to determine a lower interest rate for the customer's credit card. The bank can also offer programs for the customer to reduce the interest rates of the account by a specified amount upon reaching certain thresholds in the investment account.

The customer's investment account can also serve as an asset, equity interest or collateral for loans or protection against default and bad debts. Thus, the investment account provides additional features for the credit card account as well as additional benefits to the credit card holder, beyond the mere existence of the credit card account or the investment account.

In order to promote loyalty to the scheme, the bank or issuer could provide a bonus payment or a rebate of, say, ½to 1% of the card holder's charge during the relevant period. This amount could be increased with longevity, thereby encouraging the customer's loyalty and discouraging churn. In contrast to conventional rebate schemes, this rebate can be in conjunction with the investment account.

With conventional credit card accounts the bank or issuer is able to gain revenues from, for example, annual account fees, merchant fees or from interest charged on a daily balance in the credit account. In the system of the present invention, the monies held in the log or essentially credited to the institution, but static as far as the customer is concerned. Thus, the asset is the bank's to deal in until it is assigned to a financial vehicle at the end of the accounting period. Furthermore, the bank or issuer is able to gain additional revenues from a portion of the investment interest gained on the investment account or other financial vehicle. The bank may also be able to gain revenues from the fees associated with the investments chosen for the investment account. Moreover, the addition of the investment account will add to the overall assets held by the bank or institution. One or more of these advantages can be achieved by the bank or card issuer, all in the context of current card account users. In other words, the round-up system can be an added feature to a credit card account that does not require a separate card or new account review procedure.

The system of the present invention can also be used in conjunction with company loyalty programs or rebates. For example, consumer product companies could. give a discount on purchases of their products (say 5-15%) when using this system which would then be credited to the card holder's investment account or other financial vehicle. The product company can recoup some of the discounted value through fees associated with a portion of the investment proceeds.

It will be apparent from the foregoing that the present invention can be realised in many different ways. The invention is not limited to those described herein, but only according to the spirit and scope of the following claims.

1. A system for deriving funds for a financial vehicle on behalf of a customer, the system comprising:
input means for entering data on financial transactions to a customer account in memory means;
processor means for increasing the value of each transaction to an amount and for entering the increase in the amount in a log in the memory means; and
means for establishing the end of an accounting period and for generating an output signal, the processor means being responsive to the output signal at the end of the accounting period, and to credit the increase(s) in the amount(s) to the financial vehicle on behalf of the customer.

2. A system as claimed in claim 1 in which the accounting period for the log coincides with the accounting period for the customer account.

3. A system as claimed in claim 1 in which the accounting period for the log is determined by the amount in the log reaching a predetermined threshold.

4. A system as claimed in claim 1 in which the accounting period for the log is a multiple of the accounting period of the customer account.

5. A system as claimed in any of claims 1 to 4 in which the increased amounts are transferred directly from the customer account to the investment vehicle.

6. A system as claimed in any preceding claim in which the data includes a marker identifying the financial transaction as one on which the system is to be applied.

7. A system as claimed in any preceding claim in which the customer account is a credit card account or merchant account.

8. A system as claimed in claim 7 comprising means for determining an interest rate for the credit card account or merchant account using a current total of the amount(s) credited to the financial vehicle, so that the interest rate is dependent on the current total amount.

9. A system as claimed in any of claims 1 to 6 in which the customer account is a money transmission account.

10. A system as claimed in any preceding claim in which the financial transactions are credit/debit/smart card transactions, cheque presentations, standing orders, direct debits and/or billable good/service entries in the customer account.

11. A system as claimed in any preceding claim in which the processor means are operable to increase the value of each transaction to the value of the nearest predetermined currency unit of a set of predetermined currency units, for example consecutive integer currency amounts.

12. A system as claimed in any of claims 1 to 9 in which the processor means are operable to increase the value of each transaction by a percentage of that value.

13. A system as claimed in any of claims 1 to 9 in which the processor means are operable to increase the value of each transaction by a fixed amount.

14. A system as claimed in any of claims 1 to 9 in which the processor means are operable to increase the value of each transaction by the value of the transaction.

15. A system as claimed in any preceding claim in which the customer account is held in an addressable space of the same memory means holding the log in another addressable space thereof.

16. A system as claimed in any preceding claim in which the means for establishing the end of the accounting period are timer means.

17. A system as claimed in any of claims 1 to 15 in which the means for establishing the end of the accounting period are responsive to the number of entries to the log.

18. A system as claimed in any preceding claim in which the financial vehicle is an investment fund or investment account.

19. A system as claimed in any preceding claim in which the process and means are responsive to a customer input to vary the increase applied to transactions.

20. A system as claimed in claim 19 in which the user input is effected remotely over a communications network.

21. A system claimed in any preceding claim including multiple customer accounts in the memory means, having different increases applied to transactions associated with the different accounts.

22. A system as claimed in any preceding claim including multiple financial vehicles, the increases being assigned to the financial vehicles according to predetermined proportions.

23. A computer program product, directly loadable into the internal memory of a digital computer, comprising software code portions for creating the customer account and the log and for running the system on the processor means as claimed in claim 1 when said product is run on a computer.

24. A method of deriving funds for a financial vehicle on behalf of a customer, the method comprising:
entering data on financial transactions to a customer account;
increasing the value of each transaction to an amount and entering the increase in the amount in a log;
establishing the end of an accounting period; and
crediting the increase(s) in the amount(s) to the financial vehicle at the end of the accounting period on behalf of the customer.
